(19) United States
(12) Patent Application Publication
(10) Pub. No.: US 2018/0139480 A1
(43) Pub. Date: May 17, 2018

(54) SYSTEMS AND METHODS FOR DIGITAL VIDEO SAMPLING AND UPSCALING

(71) Applicant: TMM, Inc., Wilmington, DE (US)

(72) Inventors: Angelia TAI, Vancouver (CA); David KERR, Vancouver (CA); Nicolas BERNIER, Vancouver (CA); Vitus LEE, Burnaby (CA)

(21) Appl. No.: 15/574,229

(22) PCT Filed: May 11, 2016
(86) PCT No.: PCT/US2016/031871

§ 371 Date: Nov. 15, 2017

Related U.S. Application Data
(60) Provisional application No. 62/162,264, filed on May 15, 2015.

(51) Int. Cl. H04N 21/2343; H04N 21/233; H04N 21/231

(52) U.S. Cl. CPC H04N 21/234363; H04N 21/231; H04N 21/233

(57) ABSTRACT

Disclosed is a method of performing upscaling that includes the steps of: parsing an input video; breaking the input video into individual frames; performing upscaling on the individual frames to produce upscaled frames; and stitching the upscaled frames together to produce an upscaled video.

### PRIORITY

This application is being filed on 11 May 2016, as a PCT International patent application, and claims priority to U.S. Provisional Patent Application No. 62/162,222, filed May 15, 2015, the disclosure of which is hereby incorporated by reference herein in its entirety.

### INTRODUCTION

Many older videos or parts of videos/reels were prepared in resolutions lower than 4KUHD of which many of these videos are required to be played at 4K UHD. As a result, production companies are required to upscale individual frames to the desired resolution so that they can be played as part of an overall 4K UHD video. Aspects of the present disclosure relate to an efficient work-flow for upscaling video frames. The technology disclosed herein may be employed to upscale videos regardless of the exact format the video is encoded in. Resulting frame or videos produced by the example systems and methods disclosed herein may be “stitched” to any existing 4K UHD videos. The aspects disclosed herein also support audio that accompanies a video.

### BRIEF DESCRIPTION OF THE DRAWINGS

The same number represents the same element or same type of element in all drawings.

FIG. 1 is a diagram of an exemplary workflow for performing upsampling.

FIG. 2 is an exemplary workflow system.

FIG. 3 is an embodiment of a method for upscaling a video.

FIG. 4 illustrates one example of a suitable operating environment in which one or more of the present embodiments may be implemented.

FIG. 5 is an embodiment of an exemplary network in which the various systems and methods disclosed herein may operate.

### SUMMARY

In one aspect, the invention relates to a method of performing upscaling that includes the steps of: parsing an input video; breaking the input video into individual frames; performing upscaling on the individual frames to produce upscaled frames; and stitching the upscaled frames together to produce an upscaled video.

### DETAILED DESCRIPTION

The aspects disclosed herein relate to systems and methods for performing digital video sampling and upscaling. For example, the various aspects disclosed herein provide a workflow that may be employed to upscale content. Exemplary forms of content include audio content, video content, images, etc. However, for ease of discussion the aspects disclosed herein will be described with respect to performing upscaling on videos. Aspects of the present disclosure provide a platform independent workflow that can be employed in any type of operating environment. Aspects disclosed herein provide enhanced processing throughput and reduce storage requirements than traditional video upscaling. Furthermore, the aspects disclosed are require less processing capability and/or computing resources than traditional solutions, which allow the systems and methods disclosed herein to operate on devices that cannot support traditional upsampling solutions.

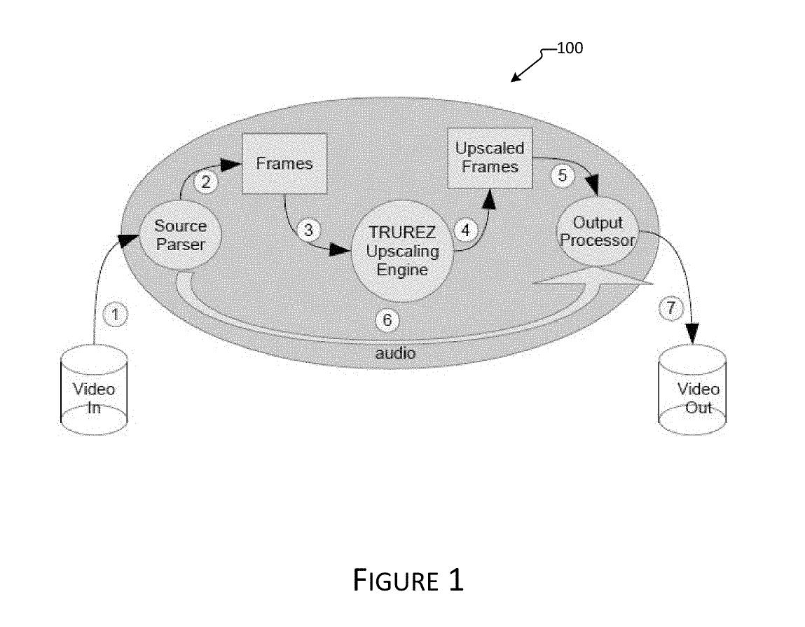

FIG. 1 is a diagram of an exemplary workflow 100 for performing upsampling. The exemplary workflow may be implemented using hardware, software, or a combination of hardware and software. In examples, the workflow 100 may be used to process video and/or audio content. However, one of skill in the art will appreciate that the workflow 100 may be employed with other types of content without departing from the spirit of this disclosure. The depicted workflow includes seven different processing paths. However, one of skill in the art will appreciate that more or fewer processing paths may be deployed without departing from the scope of this disclosure.

The first step of the workflow, identified by reference number 1 in the workflow 100, may comprise retrieving an input video. The input video may be raw frames as well as any supported formats such as WebM, H.264/H.265, etc. The input video may be in any container such as MP4, AVI or MKV, etc. A raw video is larger in size which could result in a high number of disk reads to of disk reads. Having to read from disk is expensive as disk accesses are slow compared to memory accesses. In examples, a solid-state drive (SSD) may be employed to speed up the retrieval process.

The second step of the workflow, identified by reference number 2 in the workflow 100, may include parsing the video file to split the input video into frames. In examples, the splitting process may also separate the audio track from the input video. In one example, the splitting may be performed by a source parser. The source parser may determine the format of the input video stream. The format of the input video stream may determine how the incoming video stream should be split into individual frames. For example, the method of splitting the frames may vary depending the type of encoding (or lack thereof) used on the input video stream. If the input video stream is encoded, the source parser may split the video stream by decoding the stream data into individual frames. The source parser may also determine the size of each frame. More specifically, the source parser may determine the width and height (the resolution) of the frames. The source parser may also analyze the input video stream to gather information about the video container.

The third step of the workflow, identified by reference number 3 in the workflow 100, may include processing the input video stream to produce an upscaled stream. In one example, each frame of the input video stream may be upscaled. For example, once the individual frames are determined, the frames may be processed by an upscaling or upsampling engine. The frames may be upscaled using any type of upscaling or upsampling algorithm, such as, for example, a self-similarity based algorithm, a bilinear algorithm, bicubic interpolation, or any other type of upscaling algorithm. In examples, the amount of upscaling can vary depending on need. For example, a 2× upscaling may be perform, a 4× upscaling, etc. After the upscaling is performed, the workflow continues to fourth step, identified by reference number 4 in workflow 100, where the upscaled frame is saved. In one example, each upscaled frame may be saved separately. In other examples, the upscale frames may be stored in a single file that contains all of the upscaled frames for the input video stream.

The fifth step of the workflow, identified by reference number 5 in the workflow 100, where the upscaled frames are stitched together. In examples, each stored upsampled frames may be reassembled into an upsampled video by an output processor during the fifth step. In further examples a sixth step may be performed, indicated by reference number 6 in the workflow 100, in which the audio track from the input video may also be received or retrieved and then combined with the stitched video frames to produce a final upsampled video that includes audio. In examples, the stitching may result in raw video. In aspects, if the source video has an audio track, the source parser may extract the audio information and ensure the audio information is made available for the output processor. In the seventh step of the workflow, indicated by reference number 7 in the workflow 100, the final upsampled video may be stored. In one example, the final upsampled video may be stored in raw format. In other examples, the final upsampled video may be encoded prior to storing it.

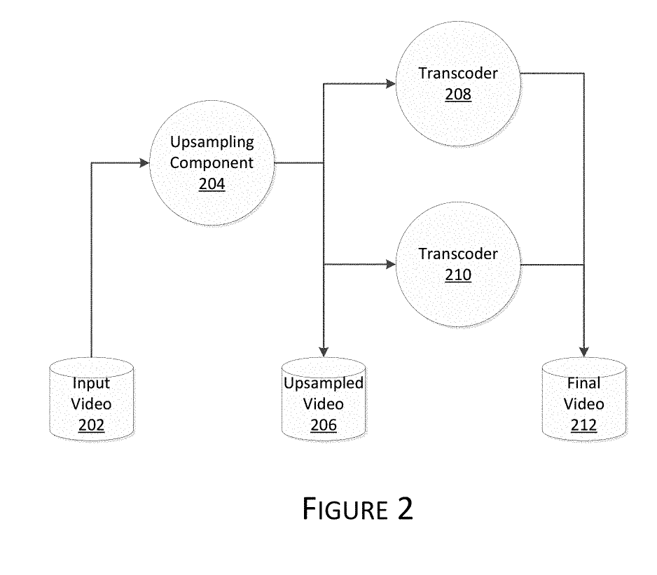

FIG. 2 is an exemplary workflow system 200. The exemplary workflow system includes an input video store 202. Input videos are retrieved from the input video store 202 and processed by upscaling component 204. In examples, the upscaling component 204 may perform the operations described with respect to the workflow 100 described in FIG. 1. The upsampled video produced by the upscaling component 204 may be stored in an upsampled video store 206. The upsampled video may then be retrieved from the upsampled video store 206 and provided to one or more transcoders, such as transcoder component 208 and transcoder component 210. In examples, each transcoder component may encode the upsampled video according to a particular video format or codec. As such, a single upsampled video may be encoded into one or more different video formats, such as, for example, as WebM, H.264/H.265. The encoded video(s) produced by the one or more video transcoders may then be stored in an encoded video store 212. While the system 200 is illustrated as having three separate data stores, one of skill in the art will appreciate that a single data store may be employed to store the videos during the various stages of processing.

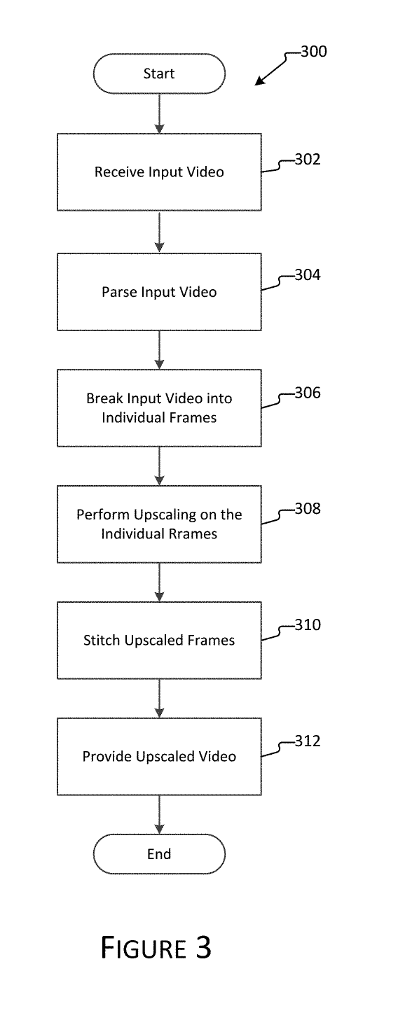

FIG. 3 is an embodiment of a method 300 for upscaling a video. In examples, method 300 may be executed on a device comprising at least one processor configured to store and execute operations, programs or instructions. However, method 300 is not limited to such examples. The method 300 may be implemented in hardware, software, or a combination of hardware and software. In other examples, method 300 may be performed by an application or service executing a location-based application or service. Flow begins at operation 300 where an input video is retrieved. In examples, the input video may be retrieved in raw data format. In other examples, the input video may be retrieved in an encoded format.

Flow continues to operation 304 where the input video is parsed. In one aspect, parsing the input video may include separating one or more audio tracks from the video. In further examples, if the input video is encoded, the input video may be decoded during parsing operation 304. After the audio tracks are separated from the video, flow continues to operation 306 where the input video is broken into individual frames. In one example, each individual frame may be stored separately. In alternate examples, all of the individual frames may be stored in a single file. Flow continues to operation 308 where each frame is upscaled. The frames may be upscaled using any type of upscaling or upsampling algorithm, such as, for example, a self-similarity based algorithm, a bilinear algorithm, bicubic interpolation, or any other type of upscaling algorithm. In examples, the amount of upscaling can vary depending on need. For example, a 2× upscaling may be perform, a 4× upscaling, etc.

Flow continues to operation 310 where the upscaled frames are stitched together. In one example, stitching the upscaled frames together may include stitching an audio track to the upscaled frames. The stitching operation 310 may be used to generate an upscaled video. Flow proceeds to operation 312 where the upscaled video is provided. Providing the upscaled video may include storing the upscaled video in a data store. In other examples, providing the video may include sending the upscaled vide to a display.

Having described various embodiments of systems and methods that may be employed to subject-oriented compression, this disclosure will now describe an exemplary operating environment that may be used to perform the systems and methods disclosed herein. FIG. 3 illustrates one example of a suitable operating environment 300 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

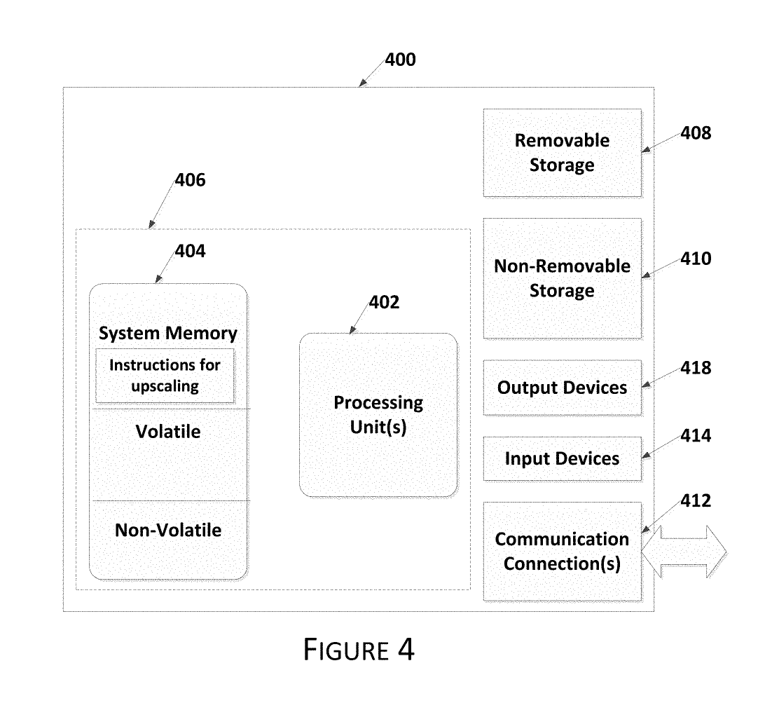

In its most basic configuration, operating environment 400 typically includes at least one processing unit 402 and memory 404. Depending on the exact configuration and type of computing device, memory 404 (storing, instructions to perform the upscaling embodiments disclosed herein) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as keyboard, mouse, pen, voice input, etc. and/or output device(s) 416 such as a display, speakers, printer, etc. Also included in the environment may be one or more communication connections, 412, such as LAN, WAN, point to point, etc. In embodiments, the connections may be operable to facility point-to-point communications, connection-oriented communications, connectionless communications, etc.

Operating environment 400 typically includes at least some form of computer readable media. Computer readable media can be any available media that can be accessed by processing unit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

The operating environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

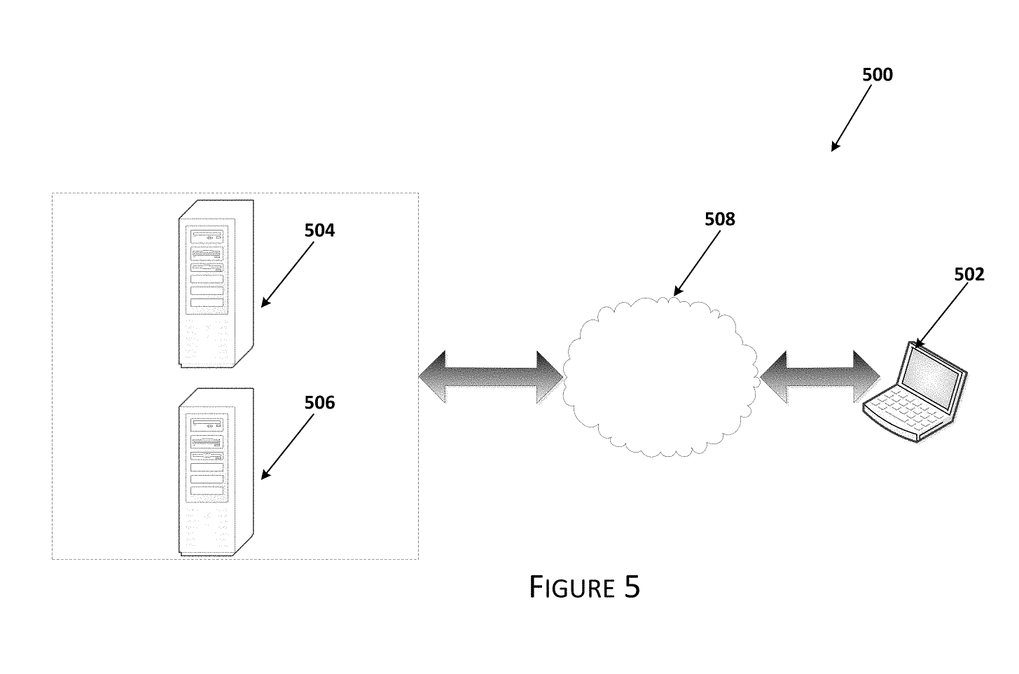

FIG. 5 is an embodiment of a system 500 in which the various systems and methods disclosed herein may operate. In embodiments, a client device, such as client device 502, may communicate with one or more servers, such as servers 504 and 506, via a network 508. In embodiments, a client device may be a laptop, a personal computer, a smart phone, a PDA, a netbook, a netbook, a tablet, a phablet, a convertible laptop, a television, or any other type of computing device, such as the computing device in FIG. 5. In embodiments, servers 504 and 506 may be any type of computing device, such as the computing device illustrated in FIG. 5. Network 508 may be any type of network capable of facilitating communications between the client device and one or more servers 504 and 506. Examples of such networks include, but are not limited to, LANs, WANs, cellular networks, a WiFi network, and/or the Internet.

In embodiments, the various systems and methods disclosed herein may be performed by one or more server devices. For example, in one embodiment, a single server, such as server 504 may be employed to perform the systems and methods disclosed herein. Client device 502 may interact with server 504 via network 508 in order to access data or information such as, for example, a video data for upscaling. In further embodiments, the client device 506 may also perform functionality disclosed herein.

In alternate embodiments, the methods and systems disclosed herein may be performed using a distributed computing network, or a cloud network. In such embodiments, the methods and systems disclosed herein may be performed by two or more servers, such as servers 804 and 806. In such embodiments, the two or more servers may each perform one or more of the operations described herein. Although a particular network configuration is disclosed herein, one of skill in the art will appreciate that the systems and methods disclosed herein may be performed using other types of networks and/or network configurations.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments are described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

We claim:

1. A method of performing upscaling, the method comprising:
parsing an input video;
breaking the input video into individual frames;
performing upscaling on the individual frames to produce upscaled frames; and
stitching the upscaled frames together to produce an upscaled video.
